(19) United States
(12) Patent Application Publication
(10) Pub. No.: US 2026/0320378 A1
(43) Pub. Date: Oct. 15, 2026

(54) INTENT-GUIDED CONDITION EXPRESSION GENERATION FOR JOURNEY ORCHESTRATION SYSTEMS

(71) Applicant: Adobe Inc., San Jose, CA (US)

(72) Inventors: Amokh VARMA, Noida (IN); Siddarth RAMESH, Noida (IN); Xavier Pierre GROSJEAN, Paris (FR); Camel AISSANI, Livry-Gargan (FR); Balaji KRISHNAMURTHY, Noida (IN); Nikaash PURI, New Delhi (IN); Stephane ARENE, Paris (FR); Elodie Soanindriana RAFALIMANANA, Sceaux (FR); Thomas BOUCHER, Hanches (FR); Francoise CORVAISIER, Paris (FR); David MENDEZ ACUNA, Paris (FR)

(21) Appl. No.: 19/179,646

(22) Filed: Apr. 15, 2025

(51) Int. Cl. G06N 3/08; G06F 40/40

(52) U.S. Cl. CPC G06N 3/08; G06F 40/40

(57) ABSTRACT

Some aspects relate to technologies for intent-guided generation of condition expressions for journey orchestration systems by leverage journey authoring data. In accordance with some aspects, training the generative model involves accessing journey authoring data for a number of journeys, where the journey authoring data includes a number of condition nodes. Training data comprising a number of training samples is generated using the journey authoring data. Each training sample can be generated using a condition expression and a condition description from a condition node. The generative model is trained using the training data to provide a trained generative model. Once trained, the generative model is employed to automatically convert natural language inputs to condition expressions.

### BACKGROUND

Journey orchestration systems are sophisticated tools designed to manage and optimize customer digital experiences across various touchpoints. These systems facilitate the generation of journeys by mapping out a series of interactions that guide customers towards a desired outcome, such as making a purchase or resolving an issue. Each journey is created by defining a sequence of steps, each representing a specific interaction or event. Condition nodes play an important role in this process, as they introduce decision points based on predefined conditions. For example, a condition node might check if a customer has opened an email or visited a website. Depending on the outcome, the journey can branch into different paths, ensuring a personalized and relevant experience for each customer.

### SUMMARY

Some aspects of the present technology relate to, among other things, intent-guided condition expression generation for journey orchestration systems. In some aspects, the technology includes training a generative model to convert natural language inputs into condition expressions using journey authoring data. The training process includes extracting pairs of condition descriptions and condition expressions from condition nodes within journey authoring data. The condition descriptions are used as proxies for intent associated with each condition node. In some aspects, these pairs can be augmented with alternative condition descriptions for the extracted condition descriptions. Training samples are generated, where each training sample includes a training input (based on a condition description) paired with a target expression (based on a corresponding condition expression). The generative model is trained by providing training inputs from the training samples to the generative model, which generates output expressions from the inputs. Losses are determined based on the output expressions and target expressions from the training samples, and parameters of the generative model are updated based on the losses.

Once trained, the generative model is used to generate condition expressions from natural language inputs. A natural language input is received, for instance, from a user authoring a condition node for a journey using a journey orchestration system. An input based on the natural language input is provided to the generative model, which outputs one or more condition expressions. In some aspects, post-processing is performed to ensure that the generated condition expressions are syntactically correct and contextually appropriate for use in the journey orchestration system. For instance, this can include adjusting fields and segment names to match a relevant schema. In instances in which multiple condition expressions are generated for a given natural language input, the condition expressions can be ranked based on relevance to the natural language input, and a subset of condition expressions to provide as output can be selected based on the rankings.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system in accordance with some implementations of the present disclosure;

FIG. 2 is a diagram illustrating an example training sample that includes a training prompt and a target expression in accordance with some implementations of the present disclosure;

FIG. 3 is a block diagram illustrating an example operation for training a generative model to convert natural language inputs to condition expressions in accordance with some implementations of the present disclosure;

FIG. 4 is a block diagram illustrating an example operation of using a trained generative model to convert a natural language input to a condition expression accordance with some implementations of the present disclosure;

FIG. 5 is a flow diagram showing an example method for leveraging journey authoring data to generate training data to train a generative model for condition expression generation in accordance with some implementations of the present disclosure;

FIG. 6 is a flow diagram showing an example method for training a generative model to convert natural language inputs to condition expressions in accordance with some implementations of the present disclosure;

FIG. 7 is a flow diagram showing an example method for using a trained generative model to generate a condition expression from a natural language input in accordance with some implementations of the present disclosure; and

FIG. 8 is a block diagram of an exemplary computing environment suitable for use in implementations of the present disclosure.

### DETAILED DESCRIPTION

### Definitions

Various terms are used throughout this description. Definitions of some terms are included below to provide a clearer understanding of the ideas disclosed herein.

As used herein, a “journey orchestration system” refers to a computer-based tool designed to manage and optimize customer digital experiences across various touchpoints. These systems facilitate the generation of journeys by mapping out a series of interactions that guide customers towards a desired outcome, such as making a purchase or resolving an issue. For example, a journey orchestration system can allow users to author journeys and use the journeys to track customer information and interactions to create provide digital experiences based on the tracked information.

A “journey” refers to a sequence of steps or interactions that a customer experiences as they engage with an organization's digital platforms. Each step in the journey represents a specific interaction or event, such as opening an email, clicking a link, or making a purchase. For instance, a journey might start with a customer receiving a promotional email, followed by visiting the company's website, and ultimately making a purchase. “Journey authoring data” comprises the information and metadata used to define and create journeys within a journey orchestration system. This data includes the sequence of events, activities, and conditions that control the actions performed for each customer. For example, journey authoring data might include JSON files that specify the steps and decision points in a marketing campaign.

The term “condition node” is used herein to refer to a decision point within a journey that introduces branching based on predefined conditions. Condition nodes evaluate specific criteria to determine the next step in the journey, ensuring a personalized experience for each customer. For example, a condition node might check if a customer has opened an email or visited a website, and based on the outcome, direct the customer down different paths.

A “condition expression” is the actual logic or rule applied at a condition node to evaluate whether certain conditions are met. A condition expression uses a combination of syntax, variables, and logical operators to define the criteria for branching within a journey.

A “condition description” provides a natural language explanation or label for a condition node, making it easier for users to understand the purpose of the condition. This description helps to convey the intent behind the corresponding condition expression. For example, a condition description might state, “Check if the customer has opened the promotional email.”

As used herein, a “schema” is a structured framework that defines the organization and format of data within a journey orchestration system. A schema can set forth the fields and segment names that are used to store and retrieve data relevant to customer journeys. A “field” is a specific identifier for an attribute specified by a schema. For example, a schema might define fields such as “customerID” and “emailaddress.” A “segment name” is a specific identifier used to categorize and group customers based on shared attributes or behaviors. For example, a segment name might be “frequentbuyers,” which includes customers who make purchases regularly. Fields and segment names are used in condition expressions to identify the customer data to employ for determining the outcome of a condition node for a given customer.

### Overview

Practitioners using journey orchestration systems often encounter a significant challenge in creating effective user journeys due to the complexities associated with defining conditions within the condition nodes. These nodes are an important component of journey creation as they determine how users are segmented into different paths, ensuring personalized treatment for each group. However, the process of defining conditions demands the creation of complicated condition expressions that accurately capture the desired criteria. Not only does this require expertise in syntax and logical operators, but it also necessitates selecting the appropriate fields and/or segment names from a relevant schema to ensure relevance.

Automating the creation of condition expressions for practitioners is challenging due to several factors. First, use of pretrained large language models (LLMs) is not feasible as the LLMs are not equipped to address this challenge due to their lack of knowledge about the relevant data schema specific to each customer. Moreover, the syntax of condition expressions are typically proprietary to each journey orchestration platform, rendering LLMs incapable of intrinsically generating condition expressions in a zero-shot setting. Even when different entities use the same journey orchestration system, different syntaxes are required because the entities have different data schemas. For instance, two different entities using the same journey orchestration system could have different schemas and hence require different syntaxes for their condition expressions.

Another existing approach is the use of state-of-the-art programming models (e.g., CodeX) to generate condition expressions. However, these models are trained on a large corpus of code, which encompasses multiple programming languages like Python, C++, Java etc. These languages are often different from the language used in condition expressions. While they share certain features, the differences are sufficient to disallow the necessary utility. Other similar methods include SQL condition generation methods (e.g., Text-to-SQL) in NLP (Natural Language Processing). However, these methods have the following drawbacks: they do not guarantee the syntactic correctness of the generated expressions; they do not provide guardrails against hallucinations of the LLMs; and they do not provide the flexibility to adapt to various user-specific schemas.

Aspects of the technology described herein provide an improved approach to automated condition expression generation that addresses the technical shortcomings of existing approaches. In accordance with some aspects, pairs of condition expressions and condition descriptions are extracted from existing journey authoring data and are used to train a generative model to convert natural language inputs into precise and syntactically accurate condition expressions.

The training process includes extracting pairs of condition descriptions and condition expressions from condition nodes within journey authoring data. The condition descriptions are used as proxies for intent associated with each condition node. In some aspects, these pairs can be augmented with alternative condition descriptions for the extracted condition descriptions. Training samples are generated, where each training sample includes a training input (based on a condition description) paired with a target expression (based on a corresponding condition expression). The generative model is trained by providing training inputs from the training samples to the generative model, which generates output expressions from the inputs. Losses are deter-mined based on the output expressions and target expressions from the training samples, and parameters of the generative model are updated based on the losses.

Once trained, the generative model is used to generate condition expressions from natural language inputs. A natural language input is received, for instance, from a user authoring a condition node for a journey using a journey orchestration system. An input based on the natural language input is provided to the generative model, which outputs one or more condition expressions. In some aspects, post-processing is performed to ensure that the generated condition expressions are syntactically correct and contextually appropriate for use in the journey orchestration system. For instance, this can include adjusting fields and segment names to match a relevant schema. In instances in which multiple condition expressions are generated for a given natural language input, the condition expressions can be ranked based on relevance to the natural language input, and a subset of condition expressions to provide as output can be selected based on the rankings.

Aspects of the technology described herein provide a number of improvements over existing condition expression generation techniques for journey orchestration system. By leveraging a generative model trained on journey authoring data, the invention automates the conversion of natural language inputs into precise and syntactically accurate condition expressions. This automation addresses the complexities and expertise required to manually define condition expressions, which are crucial for creating effective user journeys. The generative model is trained using pairs of condition descriptions and condition expressions extracted from condition nodes within journey authoring data, ensuring that the condition expressions generated by the trained model accurately capture the intended conditions. Additionally, the invention includes post-processing techniques to validate and adjust the generated condition expressions, ensuring their syntactic correctness and contextual appropriateness. This approach not only enhances the efficiency and accuracy of journey creation but also provides a scalable solution adaptable to various user-specific schemas. Consequently, the invention significantly improves the usability and effectiveness of journey orchestration systems, enabling the creation of personalized and relevant customer experiences with reduced effort and expertise while reducing and/or eliminating errors in generated condition expressions relative to existing techniques.

### Example System for Intent-Guided Condition Expression Generation

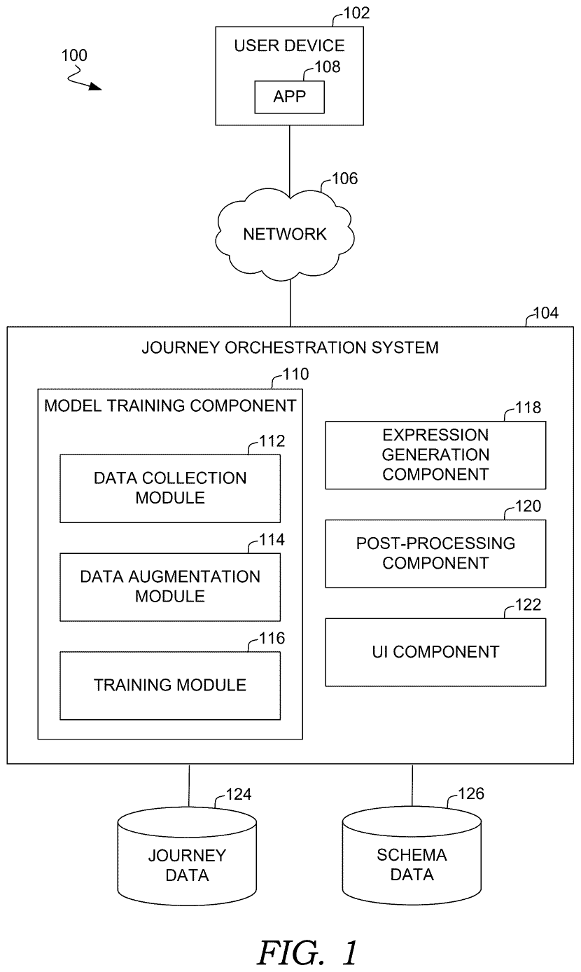

With reference now to the drawings, FIG. 1 is a block diagram illustrating an exemplary system 100 for automated conversion of natural language inputs to condition expressions by leveraging journey authoring data in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

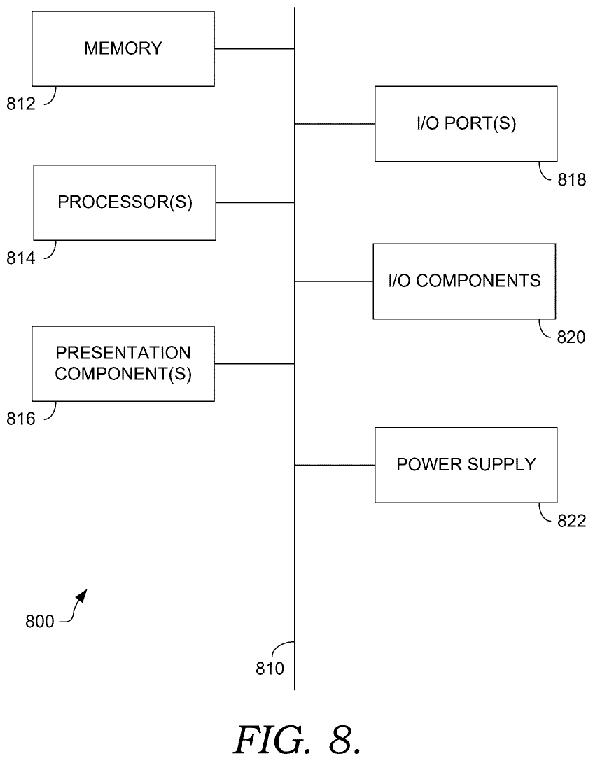

The system 100 is an example of a suitable architecture for implementing certain aspects of the present disclosure. Among other components not shown, the system 100 includes a user device 102 and a journey orchestration system 104. Each of the user device 102 and the journey orchestration system 104 shown in FIG. 1 can comprise one or more computer devices, such as the computing device 800 of FIG. 8, discussed below. As shown in FIG. 1, the user device 102 and the journey orchestration system 104 can communicate via a network 106, which may include, without limitation, one or more local area networks (LANs) and/or wide area networks (WANs). Such networking environments are commonplace in offices, enterprise-wide computer networks, intranets, and the Internet. It should be understood that any number of user devices and servers may be employed within the system 100 within the scope of the present technology. Each may comprise a single device or multiple devices cooperating in a distributed environment. For instance, the journey orchestration system 104 could be provided by multiple server devices collectively providing the functionality of the journey orchestration system 104 as described herein. Additionally, other components not shown may also be included within the network environment.

The user device 102 can be a client device on the client-side of the system 100, while the journey orchestration system 104 can be on the server-side of the system 100. The journey orchestration system 104 can comprise server-side software designed to work in conjunction with client-side software on the user device 102 so as to implement any combination of the features and functionalities discussed in the present disclosure. For instance, the user device 102 can include an application 108 for interacting with the journey orchestration system 104. The application 108 can be, for instance, a web browser or a dedicated application for providing functions, such as those described herein. This division of the system 100 is provided to illustrate one example of a suitable environment, and there is no requirement for each implementation that any combination of the user device 102 and the journey orchestration system 104 remain as separate entities. While the system 100 illustrates a configuration in a networked environment with a separate user device and journey orchestration system, it should be understood that other configurations can be employed in which aspects of the various components are combined. For instance, in some aspects, aspects of the journey orchestration system 104 can be implemented in part or in whole by the user device 102.

The user device 102 can comprise any type of computing device capable of use by a user. For example, in one aspect, the user device 102 may be the type of computing device 800 described in relation to FIG. 8 herein. By way of example and not limitation, the user device 102 can be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. A user can be associated with the user device 102 and can interact with the journey orchestration system 104 via the user device 102.

The journey orchestration system 104 generally facilitates the creation, modification, and implementation of journeys to manage digital experiences provided to users. In accordance with aspects of the technology described herein, the journey orchestration system 104 leverages journey authoring data to train a generative model to convert natural language inputs to condition expressions.

As shown in FIG. 1, the journey orchestration system 104 includes a model training component 110, an expression generation component 118, a post-processing component 120, and user interface component 122. The components/modules of the journey orchestration system 104 may be in addition to other components/modules that provide further additional functions beyond the features described herein. The journey orchestration system 104 can be implemented using one or more server devices, one or more platforms with corresponding application programming interfaces, cloud infrastructure, and the like. While the journey orchestration system 104 is shown separate from the user device 102 in the configuration of FIG. 1, it should be understood that in other configurations, some or all of the functions of the journey orchestration system 104 can be provided on the user device 102. Additionally, in some configurations, one or more of the components/modules of the journey orchestration system 104 shown in FIG. 1 can be provided by the user device 102 and/or another location not shown in FIG. 1. The components/modules can be provided by a single entity or multiple entities.

In some aspects, the functions performed by components/modules of the journey orchestration system 104 are associated with one or more applications, services, or routines. In particular, such applications, services, or routines may operate on one or more user devices, servers, may be distributed across one or more user devices and servers, or be implemented in the cloud. Moreover, in some aspects, these components/modules of the journey orchestration system 104 may be distributed across a network, including one or more servers and client devices, in the cloud, and/or may reside on a user device. Moreover, these components/modules, functions performed by these components/modules, or services carried out by these components/modules can be implemented at appropriate abstraction layer(s) such as the operating system layer, application layer, hardware layer, etc., of the computing system(s). Alternatively, or in addition, the functionality of these components/modules and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components/modules shown in example system 100, it is contemplated that in some aspects, functionality of these components/modules can be shared or distributed.

The model training component 110 trains a generative model to generate condition expressions from natural language inputs using journey authoring data. As shown in FIG. 1, the model training component comprises a data collection module 112, a data augmentation module 114, and a training module 116

The data collection module 112 obtains data from journey authoring data stored in a journey data store 124 for use in generating training data. The journey authoring data defines journeys generated by users of the journey orchestration system 104. For instance, the journey authoring data can comprise JSON (JavaScript Object Notation) files that define the journeys. The journey authoring data for each journey comprises a sequence of events and activities that control actions performed for each customer.

The journey authoring data also includes condition nodes that encapsulate conditions for selecting different pathways through each journey. A condition node is a decision point that splits the journey based on whether certain conditions are met. Each condition node includes a condition expression. A condition expression is the actual logic or rule applied at the condition node. It provides for evaluating data related to the customer or their interaction with a system to decide which path to follow. This can involve simple or complex logic based on, for instance, attributes, behaviors, or metrics associated with the customer. Typically alongside the condition expressions are condition descriptions that provide a natural language description or label that explains the condition node. For instance, the condition description for a condition expression could be obtained from text fields providing names and/or descriptions of the condition expression. This information is harnessed from the condition node as a surrogate for intent associated with each condition. In situations where this description data is missing, such data points can be discarded.

The data collection module 112 extracts pairs of condition descriptions and condition expressions from condition nodes in the journey authoring data, ensuring that each pair accurately reflects the intended condition and its corresponding expression. By leveraging the journey data, the data collection module 112 facilitates the construction of training data with training samples that serve as the foundation for training a generative model to generate accurate condition expressions from natural language inputs.

The data augmentation module 114 enhances the pairs of condition descriptions and condition expressions obtained by the data collection module with additional information. In some aspects, the data augmentation module 114 takes the condition description from each pair and provides the condition description to a pre-trained text generation model (e.g., a large language model (LLM)) to generate alternative condition descriptions. These alternative condition descriptions can be, for instance, paraphrases or other re-phrasings that capture the same or similar intent as the original condition description but are phrased differently. The data augmentation module 114 maps each alternative description to the corresponding condition expression, effectively increasing the training data available for model training. Among other things, this process ensures that the training data is diverse and robust, allowing the generative model being trained to learn to generate accurate condition expressions from a variety of natural language inputs. By augmenting the training data with alternative condition descriptions, the data augmentation module 114 helps improve the generative model's ability to generalize and accurately interpret different ways of expressing the same condition intent.

The training module 116 leverages training data provided by the data collection module 112 and/or data augmentation module 114 to train a generative model to convert natural language inputs to condition expressions. In some aspects, the training data used to train the generative model comprises training samples, where each training sample comprises a training prompt paired with a target expression. For each training sample, the training prompt is generated using a condition description (and/or alternative condition descriptions) from a condition node, while the target prompt comprises the condition expression from that condition node.

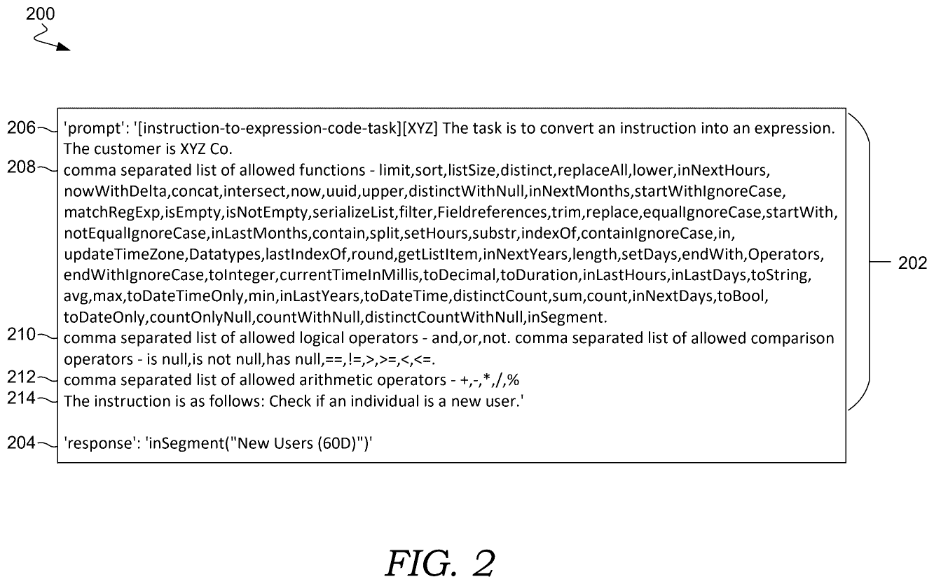

By way of illustration, FIG. 2 provides an example training sample 200. As shown in FIG. 2, the training sample includes a training prompt 202 and a target expression 204. The training prompt 202 includes general instructions 206 regarding the task to be performed by the generative model. The training prompt 202 also includes a list of allowed functions 208, a list of allowed logical operators 210, and a list of allowed arithmetic operators 212, which help direct the generative model in generating syntactically-correct expressions using the allowed functions, logical operators, and/or arithmetic operators. The training prompt 202 further includes an instruction 214, which is based on a condition expression from a condition node. In some cases, this could be text that is extracted from the condition node or other text generated from the extracted text (e.g., by the data augmentation module 114 of FIG. 1). The target expression 204 in the training sample comprises the condition expression extracted from the condition node.

In various configurations of the technology described herein, the generative model can comprise a language model that includes a set of statistical or probabilistic functions to perform NLP in order to understand, learn, and/or generate human natural language text and code. For example, a language model can be a tool that determines the probability of a given sequence of words occurring in a sentence, natural language sequence, and/or code. A language model is called a large language model (LLM) when it is trained on enormous amount of data and/or has a large number of parameters. Some examples of LLMs are GOOGLE's BERT and OpenAI's GPT-4. These models have capabilities ranging from writing a simple essay to generating complex computer codes-all with limited to no supervision. Accordingly, an LLM can comprise a deep neural network that is very large (e.g., billions to hundreds of billions of parameters) and understands, processes, and produces human natural language and code by being trained on massive amounts of text. These models can predict future words in a sequence letting them, for instance, generate sentences similar to how humans talk and write or otherwise in a form dictated, for instance, by a prompt.

In accordance with some aspects, the generative model comprises a neural network (i.e., an artificial neural network). As used herein, a neural network comprises multiple operational layers, including an input layer and an output layer, as well as any number of hidden layers between the input layer and the output layer. Each layer comprises neurons. Different types of layers and networks connect neurons in different ways. Neurons have weights, an activation function that defines the output of the neuron given an input (including the weights), and an output. The weights are the adjustable parameters that cause a network to produce a correct output.

The generative model can be trained or fine-tuned for condition expression generation using the training data. During training, weights associated with each neuron can be updated. Originally, the generative model can comprise random weight values or pre-trained weight values that are adjusted during training. In one aspect, the generative model is trained using backpropagation. The backpropagation process comprises a forward pass, a loss function, a backward pass, and a weight update. For instance, a forward pass could comprise providing a sample input from a training sample to the generative model, which generates an output. A loss could then be determined based on a comparison of the output and the ground truth data from the training sample, and weights of the generative model are updated based on the loss. This process is repeated using the training data. The goal is to update the weights of each neuron (or other model component) to cause the generative model to produce useful output when given prompts. Once trained, the weight associated with a given neuron can remain fixed. The other data passing between neurons can change in response to a given input. Retraining the network with additional training data can update one or more weights in one or more neurons.

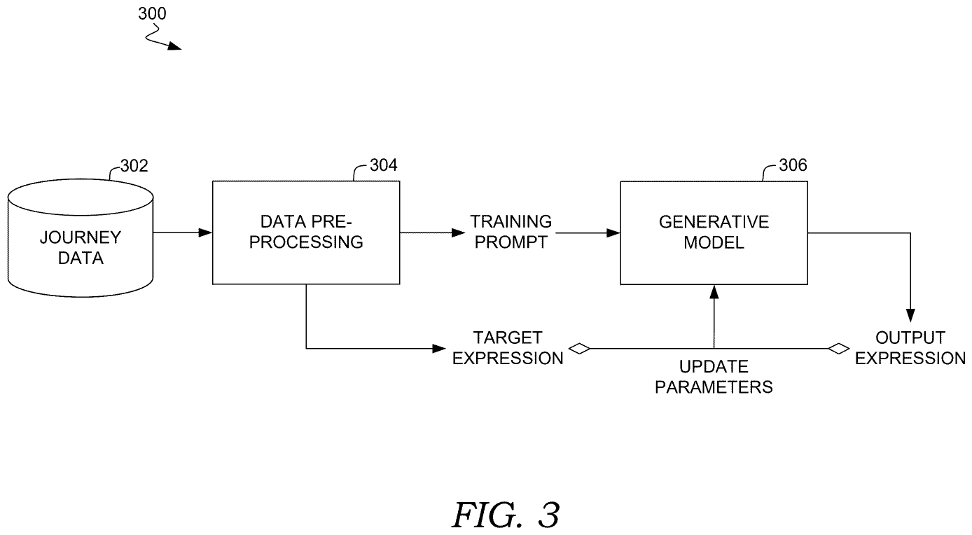

FIG. 3 provides a block diagram showing an example operation 300 for training a generative model 306 to convert natural language inputs to condition expressions. As shown in FIG. 3, journey authoring data is accessed from a journey data store 302, and data pre-processing 304 is performed to generate training data. This can include, for instance, accessing pairs of condition expressions and condition descriptions from the journey data store 302 and forming training samples from the paired data. Each training sample includes a training prompt paired with a target expression. To train the generative model 306 using a training sample, the training prompt from the training sample is provided as input to the generative model 306, causing the generative model 306 to generate an output expression. A loss is determined as a function of the output expression and the target expression from the training sample, and parameters of the generative model 306 are updated based on the loss (e.g., via backpropagation).

With reference again to FIG. 1, after model training, the expression generation component 118 uses the trained generative model to generate condition expressions. Given a natural language input, the expression generation component 118 provides a prompt based on the natural language input to the generative model, which outputs a condition expression. In some aspects, the generative model is configured to output multiple condition expressions (e.g., via nucleus sampling) for a given natural language input. When multiple condition expressions are generated for a natural language input, all generated condition expressions can be returned or a subset of the generated conditions expressions can be returned.

In some configurations, condition expressions output by the generative model for natural language inputs are provided to a post-processing component 120 to ensure the validity of the model outputs. The post-processing component 120 ensures that the generative model does not hallucinate (e.g., using non-existent fields or segments in the generated condition expressions) or otherwise generate improper or incorrect condition expressions. This post-processing avoids potential validation errors when integrating with user interfaces, thus ensuring a seamless user experience.

When the generative model provides multiple condition expressions for a given input, the post-processing component 120 can rank the condition expressions. In some aspects, the post-processing component 120 ranks the condition expressions based on relevance of each condition expression to the natural language input. The relevance can be based on similarity. For instance, the criterion for ranking could be the Jaccard similarity index calculated between the tokenized input and each tokenized condition expression. As another example, a pretrained embedding model could be used to generate an input embedding from the input and an expression embedding from each condition expression, and ranking could be based on a similarity measure (e.g., cosine similarity) between the input embedding and each expression embedding.

The post-processing component 120 can also perform field adjustments and/or segment name adjustments. In particular, condition expressions need to use fields and segment names that match the fields and segment names present in a schema, which can vary from user to user. For instance, different organizations could employ schemas that use different names to refer to the same field. To ensure condition expressions provided to users use the correct fields and segment names, the post-processing component 120 compares the fields and segment names in condition expressions output by the generative model against the fields and segment names in from a relevant schema. In some aspects, the comparison is performed using embeddings. For instance, utilizing a pretrained embedding model, embeddings can be generated for each field and segment name within the relevant schema, and the field and segment embeddings can be stored in a schema data store 126. Given a field or segment name from an expressions, an embedding of that field or segment name can be generated using the embedding model and the embedding can be used to search the schema data store 126 based on embedding similarity (e.g., cosine similarity). If an exact match is found, the field or segment name in the condition expression is left unchanged. Otherwise, the post-processing component 120 replaces the field or segment name in the condition expressions with a field or segment name from the schema having the most similar embedding.

The post-processing component 120 can also perform any number of other post-processing functions. For instance, the post-processing can also be configured to provide regex-based control of the output to ensure that journey orchestration system 104 does not provide expressions that do not correspond to the regex of a standard expression. For instance, this can include comparing each generated condition expression against acceptable patterns for expressions.

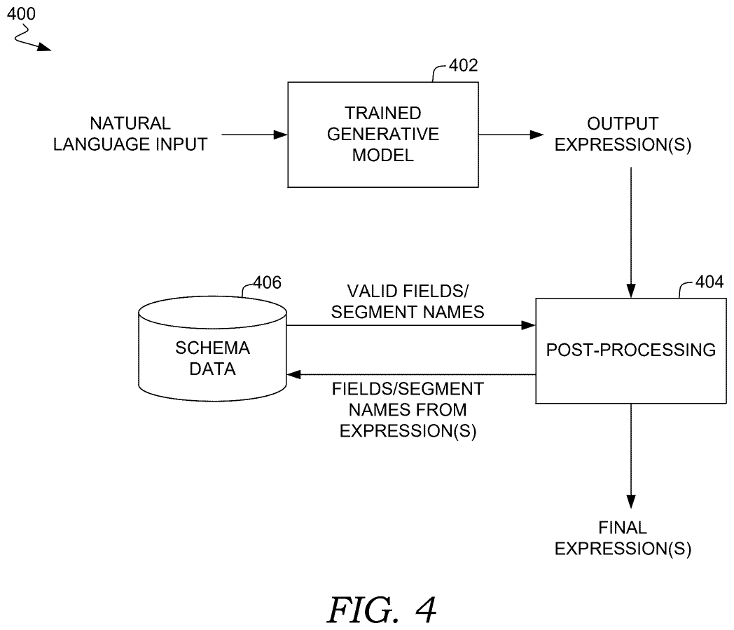

FIG. 4 provides a block diagram showing an example operation 400 for using a trained generative model 402 to convert a natural language input to a condition expression. As shown in FIG. 4, an input is provided to the trained generative model 402 based on a natural language input. For instance, a user authoring a condition node for a journey could provide the natural language input describing an intent for the condition. In some aspects, a prompt is generated from the natural language input, and the prompt is provided to the trained generative model 402, which generates one or more output condition expressions.

Post-processing 404 is then performed on the output condition expression(s). In instances in which multiple condition expressions are generated, this can include ranking the condition expressions, and in some cases, selecting a subset of the condition expressions for output. In some cases, the post-processing 404 can also include validating any fields and/or segment names in each output condition expression from the trained generative model 402. This can include comparing fields and/or segment names from each output expression with valid fields and/or segment names from a schema. For instance, the schema data store 406 can store embeddings of fields and segment names from a relevant schema, and the post-processing 404 can perform similarity matching using embeddings from the fields and/or segment names in each condition expression to determine whether to update each condition expression by replacing fields and/or segment names with valid fields and/or segment names.

Turning again to FIG. 1, the journey orchestration system 104 further includes a user interface component 122 that provides one or more user interfaces for users to interact with the journey orchestration system 104. For instance, the user interface component 122 provides one or more user interfaces to user devices, such as the user device 102. In some instances, the user interfaces can be presented on the user device 102 via the application 108, which can be a web browser or a dedicated application for interacting with the journey orchestration system 104. Among other things, the user interface component 122 can provide user interfaces for interacting with the journey orchestration system 104 to facilitate the conversion of natural language inputs to condition expressions for authoring journeys. For instance, the user interface component 122 can provide user interfaces enabling users to provide natural language inputs describing desired conditions for condition nodes of journeys being generated and/or modified. The user interface component 122 can also provide user interfaces presenting condition expressions generated by the journey orchestration system 104. For a given natural language input, the journey orchestration system 104 can generated and provide a single condition expression or multiple condition expressions. The user can then review the returned condition expression(s) and select whether to use one of the condition expressions for the condition node.

### Example Methods for Intent-guided Condition Expression Generation

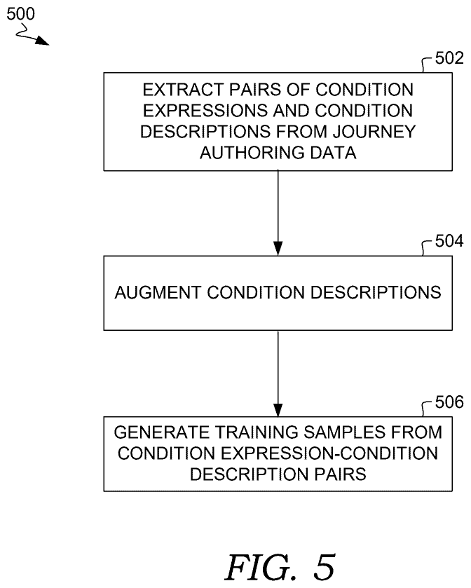

With reference now to FIG. 5, a flow diagram is provided that illustrates a method 500 for leveraging journey authoring data to generate training data to train a generative model for condition expression generation. The method 500 can be performed, for instance, at least in part by model training component 110 of the journey orchestration system 104 in FIG. 1. Each block of the method 500 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 502, pairs of condition expressions and condition descriptions are extracted from journey authoring data. This can involve, for instance, analyzing the journey authoring data to identify relevant condition nodes and extracting the associated condition expressions and condition descriptions from the condition nodes. The extraction process can be performed using various data parsing techniques, such as JSON parsing or XML parsing, depending on the format of the journey authoring data.

In the configuration of FIG. 5, the method 500 also includes augmenting the condition descriptions, as shown at block 504. This can include enhancing the extracted condition descriptions with additional information to improve their quality, diversity, and relevance. The augmentation can be performed using natural language processing techniques, such as text generation models or paraphrasing algorithms, to generate alternative condition descriptions that capture the same intent as the original condition descriptions. Each alternative condition description can be paired with the condition expression corresponding to the condition description from which it was generated.

As shown at block 506, training samples are generated from the condition expression-condition description pairs. Each training sample includes a training input (e.g., a training prompt) based on a condition description and a target expression (i.e., ground truth) based on the corresponding condition expression.

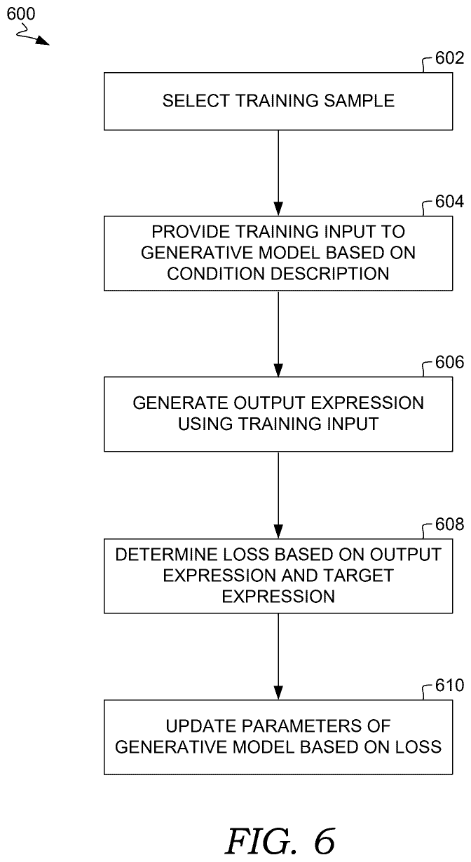

FIG. 6 is a flow diagram illustrating a method 600 for training a generative model to convert natural language inputs to condition expressions. The method 600 can be performed, for instance, at least in part by model training component 110 of the journey orchestration system 104 in FIG. 1. As shown at block 602, a training sample is selected from a training dataset (e.g., training data generated in accordance with the method 500). This involves randomly or systematically selecting a training sample (or a group of training samples) from the generated training samples. The training sample includes a training input based on a condition description and a target expression based on a corresponding condition expression.

The training input from the training sample is provided as input to the generative model, as shown at block 604. The training input could be a training prompt generated by formatting the condition description that is fed into the generative model. The training prompt can include additional instructions or context to guide the generative model. As shown at block 606, the generative model generates an output expression using the training input. The generative model processes the training input to generate a condition expression as the output.

As shown at block 608, a loss is determined based on the output expression from the generative model and the target expression from the selected training sample. For instance, a loss function can be used to quantify the difference between the output expression and the target expression. Parameters of the generative model are updated based on the loss, as shown at block 610. This involves adjusting the generative model's parameters to minimize the loss and improve its performance. The parameter updates can be performed using optimization algorithms, such as stochastic gradient descent and backpropagation, to iteratively refine the generative models parameters (e.g., weights and biases).

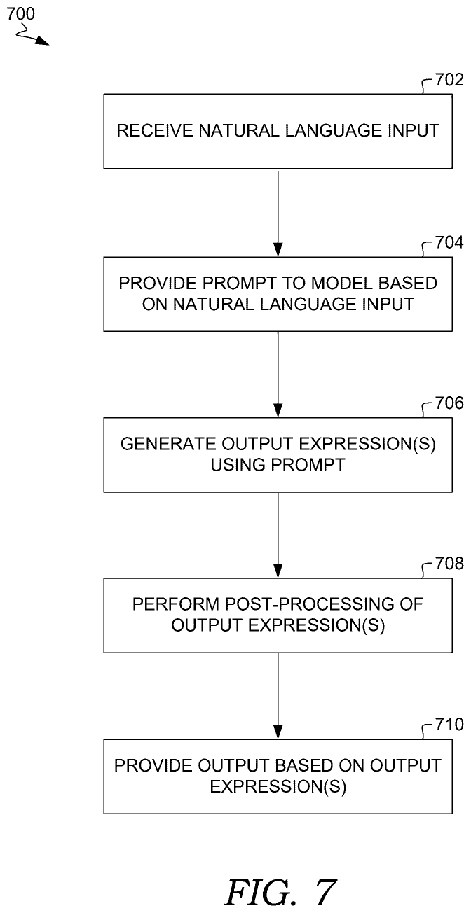

FIG. 7 is a flow diagram illustrating a method 700 for using a trained generative model to generate a condition expression from a natural language input. The method 700 can be performed, for instance, at least in part by expression generation component 118 and/or the post-processing component 120 of the journey orchestration system 104 in FIG. 1. As shown at block 702, a natural language input is received. For instance, a user of a journey orchestration system could be authoring a journey and provides a natural language input describing the intent of a condition node for the journey.

A prompt is provided to the generative model based on the natural language input, as shown at block 704. This can involve, for instance, formatting the natural language input as a prompt that can be fed into the generative model. The prompt can include additional context or instructions to guide the generative model. As shown at block 706, the generative model generates one or more output expressions using the prompt. The generative model processes the prompt and generates one or more condition expressions as the output.

As shown at block 708, post-processing of the output expression(s) is performed. Any of a variety of post-processing techniques can be employed. In some aspects, this can include refining the generated expression(s) to ensure their validity and correctness. For instance, the post-processing can include various techniques, such as syntax checking, field validation, and segment name adjustments, to ensure the expressions conform to the required format and schema. When multiple output expressions are generated for the natural language input, the post-processing can rank the output expressions, for instance, based on relevance (e.g., similarity) to the natural language input. As shown at block 710, an output is provided based on the output expression(s). The output can include one or more of the output expressions from the generative model without any refinements, one or more refined condition expressions, and/or a combination thereof. The output can be provided to a user for review and selection. For instance, the user can select a condition expression from the output for inclusion in the condition node of a journey being authored.

### Exemplary Operating Environment

Having described implementations of the present disclosure, an exemplary operating environment in which embodiments of the present technology may be implemented is described below in order to provide a general context for various aspects of the present disclosure. Referring initially to FIG. 8 in particular, an exemplary operating environment for implementing embodiments of the present technology is shown and designated generally as computing device 800. Computing device 800 is but one example of a suitable computing environment and is not intended to suggest any limitation as to the scope of use or functionality of the technology. Neither should the computing device 800 be interpreted as having any dependency or requirement relating to any one or combination of components illustrated.

The technology may be described in the general context of computer code or ma-chine-useable instructions, including computer-executable instructions such as program modules, being executed by a computer or other machine, such as a personal data assistant or other hand-held device. Generally, program modules including routines, programs, objects, components, data structures, etc., refer to code that perform particular tasks or implement particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output (I/O) ports 818, input/output components 820, and illustrative power supply 822. Bus 810 represents what may be one or more busses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one may con-sider a presentation component such as a display device to be an I/O component. Also, processors have memory. The inventors recognize that such is the nature of the art, and reiterate that the diagram of FIG. 8 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other op-tical disk storage, magnetic cassettes, magnetic tape, magnetic disk storage or other magnetic storage devices, or any other medium which can be used to store the desired information and which can be accessed by computing device 800. The terms “computer storage media” and “computer storage medium” do not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or non-volatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc. The I/O components 820 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye-tracking, and touch recognition associated with displays on the computing device 800. The computing device 800 may be equipped with depth cameras, such as, stereoscopic camera systems, infrared camera systems, RGB camera systems, and combinations of these for gesture detection and recognition. Additionally, the computing device 800 may be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described herein may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, unless indicated otherwise, the term “or” includes the conjunctive, the disjunctive, and both (a or b thus includes either a or b, as well as a and b). Further, the term “and/or” includes the conjunctive, the disjunctive, and both (a and/or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology may generally refer to the technical solution environment and the schematics described herein, it is understood that the techniques described may be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations, the operations comprising:
accessing journey authoring data for a plurality of journeys, the journey authoring data comprising a plurality of condition nodes;
generating training data having a plurality of training samples using the journey authoring data, wherein each of at least a portion of the training samples is generated using a condition expression and a condition description from a condition node from the plurality of condition nodes; and
training a generative model using the training data to provide a trained generative model that converts natural language inputs to condition expressions.

2. The one or more computer storage media of claim 1, wherein training the generative model using a first training sample from the plurality of training samples comprises:
accessing a first training prompt based on a first condition description from the first training sample,
causing the generative model to generate a first output condition expression using the first training prompt, and
updating parameters of the generative model based on a loss determined from the first output condition expression and a first target expression from the first training sample.

3. The one or more computer storage media of claim 2, wherein the first training prompt comprises text instructing the generative model to generate the first output condition expression by converting an instruction corresponding to the first condition description.

4. The one or more computer storage media of claim 2, wherein the first training prompt is augmented with one or more selected from the following: one or more allowed functions, one or more allowed logical operators, and one or more allowed comparison operators.

5. The one or more computer storage media of claim 1, wherein a first training sample of the plurality of training samples is generated by:
accessing a first condition description and a first condition expression for a first condition node;
causing a text generation model to generate an alternative condition description corresponding to the first condition description; and
generating a first training prompt using with the alternative condition description and a first target expression using the first condition expression.

6. The one or more computer storage media of claim 1, wherein the operations further comprise:
receiving a first natural language input;
causing the trained generative model to generate a first condition expression based on the first natural language input; and
providing an output based on the first condition expression.

7. The one or more computer storage media of claim 6, wherein the operations further comprise:
causing the trained generative model to generate a second condition expression based on the first natural language input; and
ranking the first condition expression and the second condition expression.

8. The one or more computer storage media of claim 6, wherein the operations further comprise:
comparing a field and/or a segment name from the first condition expression to valid fields and/or valid segment names from a schema; and
replacing the field and/or the segment name in the first condition expression with a valid field and/or a valid segment name from the schema to provide an updated condition expression, wherein the output comprises the updated condition expression.

9. A computer-implemented method comprising:
receiving, via a user interface component of a journey orchestration system, a natural language input;
generating, by a trained generative model, a condition expression from the natural language input, wherein the trained generative model was trained using pairs of condition expressions and condition descriptions from condition nodes of journey authoring data; and
providing, via the user interface component of the journey orchestration system, an output based on the condition expression.

10. The computer-implemented method of claim 9, wherein the method further comprises:
generating a prompt using the natural language input; and
providing the prompt as input to the trained generative model.

11. The computer-implemented method of claim 9, wherein the trained generative model generates a plurality of condition expressions from the natural language input, and wherein the method further comprises:
ranking the plurality of condition expressions based on relevance to the natural language input.

12. The computer-implemented method of claim 11, wherein the relevance of each condition expression from the plurality of condition expressions is determined based on similarity of each condition expression from the plurality of condition expressions to the natural language input.

13. The computer-implemented method of claim 9, wherein the method further comprises:
comparing a field and/or a segment name from the condition expression to valid fields and/or valid segment names from a schema; and
replacing the field and/or the segment name in the condition expression with a valid field and/or a valid segment name from the schema to provide an updated condition expression, wherein the output comprises the updated condition expression.

14. A computer system comprising:
one or more processors; and
one or more computer storage media storing computer-useable instructions that, when used by the one or more processors, cause the one or more processors to perform operations, the operations comprising:
accessing, by a data collection module of a journey orchestration system, journey authoring data for a plurality of journeys, the journey authoring data comprising a plurality of condition nodes;
generating, by a training module of the journey orchestration system, training data having a plurality of training samples using the journey authoring data, wherein each of at least a portion of the training samples is generated using a condition expression and a condition description from a condition node from the plurality of condition nodes; and
training, by the training module, a generative model using the training data to provide a trained generative model that converts natural language inputs to condition expressions, wherein training the generative model using a first training sample from the plurality of training samples comprises:
accessing a first training prompt based on a first condition description from the first training sample,
causing the generative model to generate a first output condition expression using the first training prompt, and
updating parameters of the generative model based on a loss determined from the first output condition expression and a first target expression from the first training sample.

15. The computer system of claim 14, wherein the first training prompt comprises text instructing the generative model to generate the first output condition expression by converting an instruction corresponding to the first condition description.

16. The computer system of claim 14, wherein the first training prompt is augmented with one or more selected from the following: one or more allowed functions, one or more allowed logical operators, and one or more allowed comparison operators.

17. The computer system of claim 14, wherein a second training sample of the plurality of training samples is generated by:
accessing a second condition description and a second condition expression for a second condition node;
causing a text generation model to generate an alternative condition description corresponding to the second condition description; and
generating a second training prompt using with the alternative condition description and a second target expression using the second condition expression.

18. The computer system of claim 14, wherein the operations further comprise:
receiving a first natural language input; and
causing the trained generative model to generate a first condition expression based on the first natural language input.

19. The computer system of claim 18, wherein the operations further comprise:
causing the trained generative model to generate a second condition expression based on the first natural language input; and
ranking the first condition expression and the second condition expression.

20. The computer system of claim 18, wherein the operations further comprise:
comparing a field and/or a segment name from the first condition expression to valid fields and/or valid segment names from a schema; and
replacing the field and/or the segment name in the first condition expression with a valid field and/or a valid segment name from the schema.
